(19) United States
(12) Patent Application Publication
(10) Pub. No.: US 2017/0228667 A1
(43) Pub. Date: Aug. 10, 2017

(54) GENERATION OF PERSONALIZED TRANSPORTATION PROPOSALS

(71) Applicant: International Business Machines Corporation, Armonk, NY (US)

(72) Inventors: Heather L. Duschl, Raleigh, NC (US); Alexandra D. Markello, Fayetteville, NC (US); Dana L. Price, Surf City, NC (US)

(21) Appl. No.: 15/015,371

(22) Filed: Feb. 4, 2016

(51) Int. Cl. G06Q 10/02

(52) U.S. Cl. CPC G06Q 10/025; G06Q 50/30

(57) ABSTRACT

Embodiments include a method, systems and computer program products to generate personalized transportation proposals. In some embodiments, user data may be received to authenticate a user. A travel itinerary may be obtained using the user data. Status information associated with the travel itinerary may be obtained. Impact on the travel itinerary may be determined based on the status information. An update proposal to the travel itinerary may be generated based on the impact of the travel itinerary. Presentation of the update proposal to the user may be facilitated. A confirmation of the update proposal may be received from the user. The travel itinerary may be modified using the update proposal.

### BACKGROUND

The present disclosure relates to data analysis, and more specifically, to methods, systems and computer program products for generation of personalized transportation proposals.

While traveling via private and public transport (e.g., plane, train, ferry, etc.), traditional internet interactions may be difficult or impose significant data or power consumption and passengers may need to rely on the staff to update them on pertinent information such as weather at the destination and connecting flight gate information. Delays in access to such information may also create delays for the remaining portion of a passenger's trip. For example, if a passenger is on a flight with limited Internet access and weather affects their arrival time, the passenger may miss their connecting flight. By the time the passenger lands, alternative connecting flights may either be already booked by other passengers or there may not be sufficient time to book an alternative connecting flight, which may ultimately delay the passenger's arrival at their final destination.

### SUMMARY

In accordance with an embodiment, a method for generation of personalized transportation proposals is provided. The method may include receiving user data to authenticate a user; obtaining a travel itinerary using the user data; obtaining status information associated with the travel itinerary; determining an impact on the travel itinerary based on the status information; generating an update proposal to the travel itinerary based on the impact of the travel itinerary; facilitating presentation of the update proposal to the user; receiving a confirmation of the update proposal from the user; and modifying the travel itinerary using the update proposal.

In another embodiment, a computer program product may comprise a non-transitory storage medium readable by a processing circuit and storing instructions for execution by the processing circuit for performing a method that may include receiving user data to authenticate a user; obtaining a travel itinerary using the user data; obtaining status information associated with the travel itinerary; determining an impact on the travel itinerary based on the status information; generating an update proposal to the travel itinerary based on the impact of the travel itinerary; facilitating presentation of the update proposal to the user; receiving a confirmation of the update proposal from the user; and modifying the travel itinerary using the update proposal.

In another embodiment, a system for optimizing persistency using hybrid memory may include a processing unit in communication with one or more types of memory. The processing unit may be configured to receive user data to authenticate a user; obtain a travel itinerary using the user data; obtain status information associated with the travel itinerary; determine an impact on the travel itinerary based on the status information; generate an update proposal to the travel itinerary based on the impact of the travel itinerary; facilitate presentation of the update proposal to the user; receive a confirmation of the update proposal from the user; and modify the travel itinerary using the update proposal.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment; and

FIG. 3 is a flow diagram of a method for generating personalized transportation proposals in accordance with an exemplary embodiment.

### DETAILED DESCRIPTION

In accordance with exemplary embodiments of the disclosure, methods, systems and computer program products for generation of personalized travel proposals are provided. A system may retrieve a travel itinerary associated with a user and may obtain status information (e.g., delays in connecting flights, weather delays, traffic delays, etc.). The system may analyze the status information to determine an impact to the travel itinerary and may generate one or more update proposals to alleviate the impact on the travel itinerary. The systems and methods described herein are directed to providing a personalized, interactive experience based on the passenger's current location, the need for problem resolution affecting travel plans, the timing of the user's travel, and the integration of this information with automatic suggestions and opportunities for interactions with the environment (e.g., airline terminal, train terminal, ferry terminal, surrounding vicinity, etc.). The systems and methods described herein provide an all-purpose, travel tool for a user to interact with an identified travel context (e.g., airports, hotels, airlines, restaurants, etc. associated with an identified network of businesses), which may provide an immediacy of information that enables a user to make and/or change reservations or itineraries in real-time or near-real-time based on the information available from the travel context.

In some embodiments, the systems and methods described herein may obtain passenger-specific updates, making reservations or changes to existing reservations, or the like, all of which is linked to the current travel status (e.g. arrival time, arrival gate, etc.) of the passenger. The system may suggest actions to the user based on changes to travel plans (e.g. a connection will be missed, here's a flight suggestion to rebook) or on current status (e.g. determining the passenger has a 2 hour layover and recommending dinner reservations at a restaurant in the terminal near the user's arrival gate).

In some embodiments, the user may interact with the system through an interactive screen (e.g., located on the seat in front of a passenger) which may be connected to the internal systems of the airline, airport, and other business partners of the airport (e.g. restaurants in the airport, rental car companies, etc.), and which may provide user alerts and make automatic recommendations based on the individual's travel plans.

For example, a passenger may be on a flight. From their seat, the passenger may use the interactive screen located on the seat in front of the passenger to enter information or otherwise identify themselves to the system (e.g., seat location, username and password, confirmation number associated with an itinerary, etc.). The system may authenticate the user so they have access to their flight information, as well as personalized information such as checked bag status, connecting flight info, etc. In some embodiments, the identity of the passenger may be determined through a variety of means, which may include flight manifest and seat assignments, scanning the boarding ticket, itinerary confirmation code, swiping a credit card, etc. In some embodiments, the passenger may use an application on a mobile device to connect to a network associated with the airline, which may be configured to only permit access via the application.

The flight status and arrival time of the flight the passenger is currently aboard may be continuously updated and displayed to the user (e.g., interactive screen, application on mobile device, etc.). The flight status and arrival time may be dependent on speed of the aircraft, weather conditions, and other factors. If there are changes, the user may be alerted.

In some embodiments, each time checked baggage associated with the passenger is moved and scanned within the airline's system, the passenger may be notified (e.g. two of your bags were scanned onto your flight, one of your bags was delivered on a different carrier and will rejoin you on your next hop). In the event of an issue that causes the baggage to arrive at the destination after the passenger, the system may allow the user to input their contact information for later final destination delivery.

In some embodiments, flight information for connecting flights of the passenger may be displayed to the user. If there is a delay in the arrival time of the current or a connecting flight, the system may calculate that the passenger may miss the connection and may recommend other flights to book. The system may retrieve information for available flights and present them to the user. Notifications of changes in travel may be sent to contacts designated by the user (e.g., parties that may responsible for picking up the passenger).

In some embodiments, the system may determine that there is sufficient time for a secondary activity (e.g., dining at a restaurant, shopping at a store) and may generate recommendations to make reservations at a restaurant or generate a map to route the passenger to a store of interest. In some embodiments, recommendations may be based on location, proximity to a user's current or predicted location, user preferences specified in a user profile, interests or affiliations as indicated in social media, or the like. The system may also present an interactive map of the immediate vicinity to allow a user to explore. In some embodiments, the user may make a reservation or order takeout from restaurants while on the flight. Pickup times or delivery times may be automatically updated within the restaurant's system as the flight status changes. In some embodiments, the passenger may order additional items from airport shops, including sundry items, snacks, or gifts. Where connection times are tight, the system may alert the restaurants/shops and facilitate immediate processing of the passenger's order (e.g., move ahead of others in queue of requests received, automatically re-arrange or update the order that deliveries are made to ensure timely delivery, automatically update any changes in delivery locations, such as departure gates, to ensure quick delivery and accurate delivery). In some embodiments, the system may enable pre-payment of goods using a credit or debit card associated with a user's profile, immediate processing of orders to ensure pick-ups and deliveries for tight connections are prioritized over other orders that do not have a tight connection, and the like.

In some embodiments, if the user needs to have in-system customer transport, they may book it through the system (i.e. wheelchair-bound passenger will need trolley service from this gate at this time to that gate by that time). In some embodiments, the system may generate transportation recommendations for leaving the airport based on the user's itinerary.

In some embodiments, the system may allow personalized, interactive chat or telephonic sessions between passenger and travel personnel (i.e. flight attendant, reservationist, luggage handling, etc.) to resolve issue or provide assistance during any of these steps.

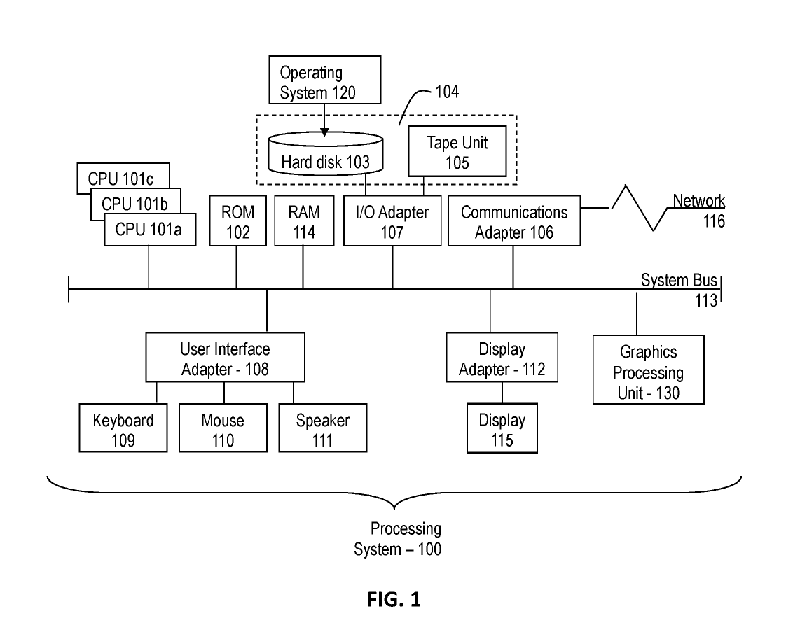

FIG. 1 depicts an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

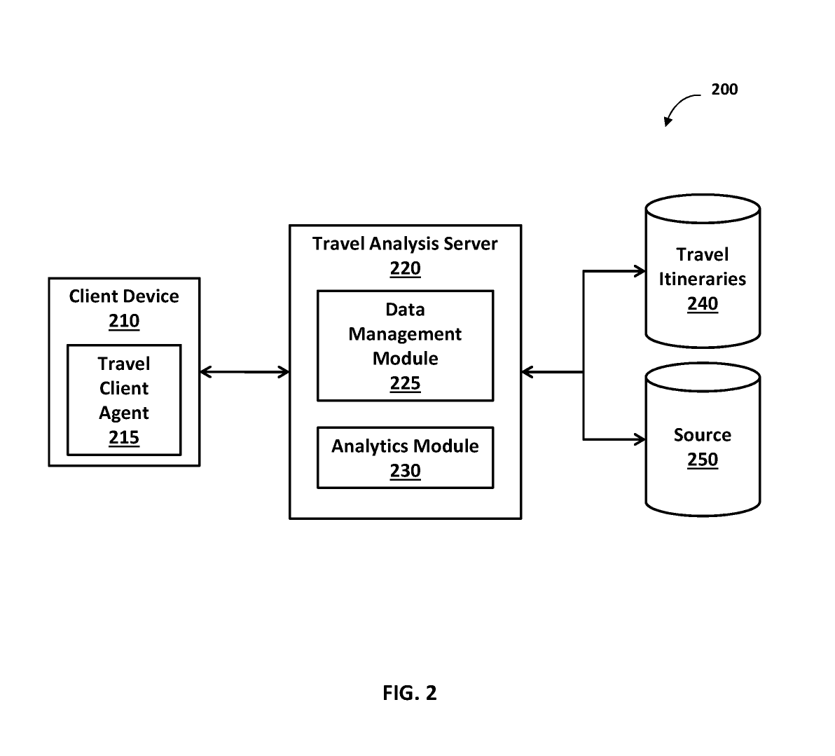

Referring now to FIG. 2, a computing system 200 in accordance with an embodiment is illustrated. As illustrated, the computing system 200 may include, but is not limited to, a client device 210, a travel analysis server 220, a travel itineraries data store 240, and/or a source data store 250.

In some embodiments, the client device 210 may be any type of user device, which may include smartphones, tablets, laptops, desktop, server, and the like. In some embodiments, the client device 210 may be a device that is integrated with a mode of transportation and connected to an internal network system of the mode of transportation (e.g., interactive screen on the back of the headrest on an airplane). The client device 210 may include a travel client agent 215. The travel client agent 215 may include computer-readable instructions that in response to execution by the processor(s) 101 cause operations to be performed including receiving information from a user, such as user credentials or a confirmation associated with a travel itinerary. The travel client agent 215 may communicate with a travel analysis server 220 to obtain relevant details associated with a travel itinerary and receive any update proposals generated by the analytics modules 230 of the travel analysis server 220, as described below. The travel client agent 215 presents the update proposals to the user and may receive an indication from the user to select or reject the update proposal or to enter additional information and/or requests. The travel client agent 215 may communicate with the travel analysis server 220, which may use the response from the user to modify their travel itinerary.

In some embodiments, the travel analysis server 220 may maybe any type of computing device, which may include desktop, server, and the like. In some embodiments, the travel analysis server 220 may include a data management module 225 and an analytics module 230. The data management module 225 may include computer-readable instructions that in response to execution by the processor(s) 101 cause operations to be performed including receiving data from a client device 210, obtaining travel itineraries from the travel itineraries data store 240, and/or status information associated with a travel itinerary from one or more sources, such as a source data store(s) 250. Examples of sources may include weather sources, traffic sources, and the like.

The analytics module 230 may include computer-readable instructions that in response to execution by the processor(s) 101 cause operations to be performed including generating one or more update proposals for travel itineraries based on the data from the data management module 225. In some embodiments, the analytics module 230 may generate one or more update proposals based on status information obtained by the data management module 225 as well as any user preferences that may have been provided by the user or in association with the travel itinerary. In some embodiments, an update proposal is a proposal that is automatically generated using data that is obtained after an itinerary has been established and that may affect one or more aspects of the itinerary. For example, after a travel itinerary is booked, new data may indicate that weather may delay a connecting flight of a booked flight. The update proposal may look for alternative flights in case the passenger is unable to make the second portion of their flight or may generate recommendations for nearby hotels in the event that an alternative flight is not available until the next day. Such data may be obtained from different sources, such as the airport, airline, or the like. The analytics module 230 may use the received data to query different aspects of the travel context or environment, which may include the airport, airlines, car rental agencies, hotels, or the like to generate alternative recommendations to the travel itinerary. Such automatically generated recommendations may enable the user to quickly change their travel itineraries without having to separately contact the different entities to determine whether any options are available if changes need to be made to their travel itineraries. In some embodiments, the analytics module 230 may generate multiple update proposals and may rank them. The analytics module 230 may transmit the update proposals to the data management module 225, which may then transmit the configurations to the client device 210 for review by a user.

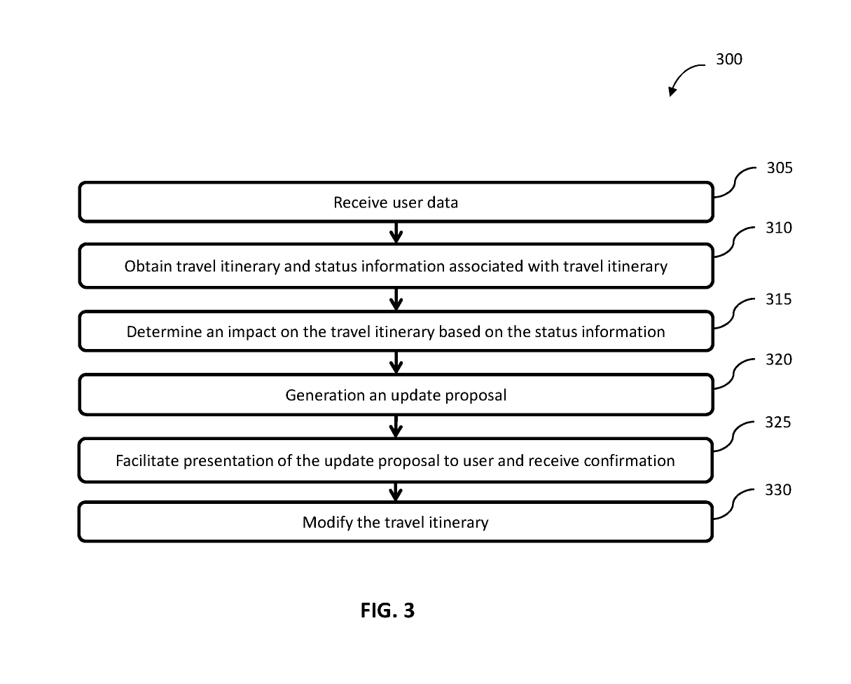

Now referring to FIG. 3, a flow diagram of a method 300 for generating personalized travel proposals in accordance with an exemplary embodiment is shown. At block 305, the data management module 225 of a travel analysis server 220 may receive user data. In some embodiments, the user data may be obtained from a travel client agent 215. The user data may be user authentication data (e.g., username and password), identity confirmation information (e.g., name, confirmation number associated with a travel itinerary, seat location on a flight, etc.). In some embodiments, the user data may be transmitted over a secure connection. To ensure the private nature of this type of information, such information is sent over a secure channel to a secure data repository.

At block 310, the data management module 225 may obtain a travel itinerary and status information associated with the travel itinerary. The data management module 225 may obtain the travel itinerary from a travel itineraries data store 240 using the user data received from the client device 210. In some embodiments, the data management module 225 may retrieve the travel itinerary and may use the data associated with the travel itinerary (e.g., flight information, destination information, etc.) to obtain status information from one or more sources, such as a source data store 250. The data management module 225 may transmit the status information, travel itinerary, and user data to the analytics module 230.

At block 315, the analytics module 230 may determine an impact on the travel itinerary based on the status information. The analytics module 230 may receive information from the data management module 225. The analytics module 230 may analyze the status information to determine an impact on the travel itinerary (e.g., traffic conditions or weather conditions that may cause delays in arrivals).

At block 320, the analytics module 230 may generate one or more update proposals to the travel itinerary. In some embodiments, the update proposal may include suggestions for different modes of transportation. For example, if a transit train is experiencing delays due to railway conditions, the analytics module 230 may suggest traveling by bus, taxi, and/or other means of transportation to travel to the user's final destination. In some embodiments, the analytics module 230 may determine, based on the on data received from the data management module 225, that the user is traveling with luggage that is atypical in size or with a large number of luggage pieces and may generate one or more update proposals using the determination to ensure that the proposed mode of transportation is capable of accommodating the luggage. For example, if a passenger is traveling with a bicycle on a transit train, the analytics module 230 may exclude suggestions for traveling in a taxi. If the passenger is traveling with large luggage, such as a large instrument, the analytics module 230 may modify a car rental reservation to upgrade to a sport utility vehicle (SUV). In some embodiments, if the analytics module 230 determines there is sufficient time in the itinerary, the analytics module 230 may generate a secondary activity proposal to add to the travel itinerary based on the impact on the travel itinerary. For example, if it is lunchtime and there is now a two-hour layover due to changes in the itinerary, the analytics module 230 may generate an update proposal that includes a reservation at a restaurant near the gate assigned to the passenger' s connecting flight.

At block 325, the data management module 225 may facilitate presentation of the one or more update proposals to the user and receive confirmation of an update proposal. In some embodiments, the analytics module 230 may generate multiple update proposals and may rank the update proposals (e.g., based on user preferences, price, time, etc.). The data management module 225 may facilitate presentation of the one or more update proposals to the user via the travel client agent 215 and may request either confirmation of the presented update proposal or selection of one of the multiple update proposals presented to the user. The user may make an indication via the travel client agent 215, which may be transmitted to the data management module 225.

At block 330, the data management module 225 may modify the travel itinerary based on the indication received from the user. In some embodiments, the user may be traveling with other people (e.g., children, friends, colleagues, etc.). In some embodiments, in response to modifying the travel itinerary of the user, the travel itineraries of the user's traveling companions may also be modified. In some embodiments, in response to modifying the travel itinerary of the user, the data management module 225 may present the same changes to the itinerary to the user's companions and may request confirmation from the companions prior to modifying their travel itineraries.

In some embodiments, the user may receive an update on related components of the travel itinerary in response to modifications made to the travel itinerary. For example, a user may receive notifications for luggage associated with the user based on the modified travel itinerary. In some embodiments, the data management module 225 may make automatic modification to later portion of the travel itinerary based on modification made to the travel itinerary by the user. For example, if a user selects to confirm a connecting flight arriving later, the data management module 225 may adjust a car rental to update the pick-up time to coincide with the user's arrival time.

Additional examples of interactions where the travel analysis server 220 may assist a passenger with their travel experience may include alerting the user about the status of their checked bag and allowing them to take action in the event the delivery of the checked bag is delayed (e.g. was scanned onto their scheduled flight or was scanned onto a later flight and will arrive at the airport one hour after the passenger does, so the passenger can input delivery address). In another example, the travel analysis server 220 may provide the user with updated connecting flight gate information, including a map of the terminal and how far of a walk it is from the arriving gate; or allow the user to explore the layover airport shops (e.g. restaurants, retail stores, lounges, etc.) using an interactive map, which may also provide functionality to make a reservation, order online for quick and timely pickup, or order online for delivery to the connecting gate. In some embodiments, the travel analysis server 220 may arrange for customer transport (e.g. wheelchair-bound passenger will need trolley service from this gate at this time to that gate by that time) or allow the user to explore the services offered by the destination airport (e.g. transportation including booking a shuttle or rental car). In some embodiments, the travel analysis server 220 may provide the weather for the user's final destination; allow the user to research options and re-book a connecting or return flight (e.g. initial leg was delayed and user is going to miss their connection, so must change their connecting flight); or allow the user to explore their destination using an interactive map. The travel analysis server may provide personalized, interactive chat or telephonic sessions between passenger and travel personnel (i.e. flight attendant, reservationist, luggage handling, etc.) and may provide notifications of changes in the travel itinerary to contacts designated by the user.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving user data to authenticate a user;
obtaining a travel itinerary using the user data;
obtaining status information associated with the travel itinerary;
determining an impact on the travel itinerary based on the status information;
generating an update proposal to the travel itinerary based on the impact to the travel itinerary;
facilitating presentation of the update proposal to the user;
receiving a confirmation of the update proposal from the user; and
modifying the travel itinerary using the update proposal.

2. The computer-implemented method of claim 1, wherein the update proposal comprises two or more different modes of transportation.

3. The computer-implemented method of claim 1, wherein generating the update proposal to the travel itinerary comprises:
determining a type of luggage or size of luggage associated with the user and the travel itinerary; and
generating the update proposal using the type of luggage or the size of luggage associated with the user and the travel itinerary, wherein the update proposal comprises a transportation option capable of accommodating the type of luggage or the size of luggage associated with the user.

4. The computer-implemented method of claim 1, further comprising:
generating a secondary activity proposal to add to the travel itinerary based on the impact on the travel itinerary.

5. The computer-implemented method of claim 1, further comprising:
modifying a second portion of the travel itinerary based on the modification to the travel itinerary.

6. The computer-implemented method of claim 1, wherein the travel itinerary of the user is associated with a second travel itinerary of a second user and the method further comprises:
modifying the second travel itinerary of a second user using the update proposal.

7. The computer-implemented method of claim 1, further comprising:
receiving an update associated with luggage associated with the user based on the modified travel itinerary; and
notifying the user of the update associated with the luggage.

8. A computer program product comprising a non-transitory storage medium readable by a processing circuit and storing instructions for execution by the processing circuit for performing a method comprising:
receiving user data to authenticate a user;
obtaining a travel itinerary using the user data;
obtaining status information associated with the travel itinerary;
determining an impact on the travel itinerary based on the status information;
generating an update proposal to the travel itinerary based on the impact of the travel itinerary;
facilitating presentation of the update proposal to the user;
receiving a confirmation of the update proposal from the user; and
modifying the travel itinerary using the update proposal.

9. The computer program product of claim 8, wherein the update proposal comprises two or more different modes of transportation.

10. The computer program product of claim 8, wherein generating the update proposal to the travel itinerary comprises:
determining a type of luggage or size of luggage associated with the user and the travel itinerary; and
generating the update proposal using the type of luggage or the size of luggage associated with the user and the travel itinerary, wherein the update proposal comprises a transportation option capable of accommodating the type of luggage or the size of luggage associated with the user.

11. The computer program product of claim 8, the method further comprising:
generating a secondary activity proposal to add to the travel itinerary based on the impact on the travel itinerary.

12. The computer program product of claim 8, the method further comprising:
modifying a second portion of the travel itinerary based on the modification to the travel itinerary.

13. The computer program product of claim 8, wherein the travel itinerary of the user is associated with a second travel itinerary of a second user and the method further comprises:
modifying the second travel itinerary of a second user using the update proposal.

14. The computer program product of claim 8, the method further comprising:
receiving an update associated with luggage associated with the user based on the modified travel itinerary; and
notifying the user of the update associated with the luggage.

15. A system, comprising:
a processing unit in communication with one or more types of memory, the processing unit configured to:
receive user data to authenticate a user;
obtain a travel itinerary using the user data;
obtain status information associated with the travel itinerary;
determine an impact on the travel itinerary based on the status information;
generate an update proposal to the travel itinerary based on the impact of the travel itinerary;
facilitate presentation of the update proposal to the user;
receive a confirmation of the update proposal from the user; and
modify the travel itinerary using the update proposal.

16. The system of claim 15, wherein the update proposal comprises two or more different modes of transportation.

17. The system of claim 15, wherein to generate the update proposal to the travel itinerary, the processor is further configured to:
determine a type of luggage or size of luggage associated with the user and the travel itinerary; and
generate the update proposal using the type of luggage or the size of luggage associated with the user and the travel itinerary, wherein the update proposal comprises a transportation option capable of accommodating the type of luggage or the size of luggage associated with the user.

18. The system of claim 15, wherein the processor is further configured to:
generate a secondary activity proposal to add to the travel itinerary based on the impact on the travel itinerary.

19. The system of claim 15, wherein the processor is further configured to:
modify a second portion of the travel itinerary based on the modification to the travel itinerary.

20. The system of claim 15, wherein the travel itinerary of the user is associated with a second travel itinerary of a second user and the processor is further configured to:
modify the second travel itinerary of a second user using the update proposal.
